(19) United States
(12) Patent Application Publication
(10) Pub. No.: US 2026/0027560 A1
(43) Pub. Date: Jan. 29, 2026

(54) CATALYST FOR SYNERGISTIC REMOVAL OF NITROGEN OXIDES AND CO AS WELL AS PREPARATION METHOD AND USE THEREOF

(71) Applicant: ZHEJIANG UNIVERSITY, Hangzhou (CN)

(72) Inventors: Yue LIU, Hangzhou (CN); Xuanrui CHENG, Hangzhou (CN); Zhongbiao WU, Hangzhou (CN)

(21) Appl. No.: 19/344,368

(22) Filed: Sep. 29, 2025

Related U.S. Application Data
(63) Continuation of application No. PCT/CN2024/083168, filed on Mar. 22, 2024.

(30) Foreign Application Priority Data
Apr. 7, 2023 (CN) 202310366890.7

(51) Int. Cl. B01J 35/53; B01D 53/86; B01J 21/04; B01J 21/06; B01J 23/72; B01J 27/18; B01J 37/00; B01J 37/06; B01J 37/08

(52) U.S. Cl. CPC B01J 35/53; B01D 53/865; B01J 21/04; B01J 21/063; B01J 23/72; B01J 27/1804; B01J 37/0027; B01J 37/06; B01J 37/08; B01D 2257/404; B01D 2257/502

(57) ABSTRACT

Disclosed are a catalyst for synergistic removal of nitrogen oxides (NOₓ) and CO as well as a preparation method and use thereof. The preparation method comprises: performing vibratory ball milling, washing, drying and calcining on aluminum isopropoxide and/or titanium isopropoxide, chlorides of five or more different metal elements and P123 and/or polyethylene glycol (PEG), stirring the obtained high-entropy oxide inner core and a gel of H₃PO₄ and Ce(NO₃)₃, and then performing vibratory ball milling, washing, drying and calcining to obtain an high-entropy oxide loaded with CePO₄ seeds; and preparing, by using ammonia water, a clear solution containing pyrophosphate and Ce(NO₃)₃ in equal stoichiometric ratios, then adding the high-entropy oxide loaded with the CePO₄ seeds and urea and/or tetrapropylammonium hydroxide (TPAH) to form a slurry, and, after hydrothermal reaction, washing, drying and calcining a solid to obtain the catalyst.

### CROSS-REFERENCE TO RELATED APPLICATIONS

This application is a continuation of International Patent Application No. PCT/CN2024/083168 with a filing date of Mar. 22, 2024, designating the United States, now pending, and further claims priority to Chinese Patent Application No. 202310366890.7 with a filing date of Apr. 7, 2023. The content of the aforementioned applications, including any intervening amendments thereto, are incorporated herein by reference.

### TECHNICAL FIELD

The present disclosure relates to the technical field of air pollution control, and particularly relates to a catalyst for synergistic removal of nitrogen oxides (NOₓ) and carbon monoxide (CO) as well as a preparation method and use thereof.

### BACKGROUND OF THE DISCLOSURE

NOₓ and CO, as air pollutants, widely co-exist in many industrial flue gases such as those emitted from coal fired power plants, coke ovens in steel industry and biomass boilers. NOₓ is an important precursor for the formation of O₃ and PM_{2.5}, and CO causes environmental problems such as ozone holes and greenhouse effects in addition to harming human health. Therefore, the simultaneous removal of NOₓ and CO is of great significance for environmental protection and human health.

At present, a CO-SCR (CO selective catalytic reduction) technology is used for synergistic removal of NOₓ and CO in most cases. However, in practical applications, industrial flue gases are typically oxygen-rich environments, which will severely restrict the occurrence of a CO-SCR reaction so as to reduce denitration efficiency. In addition, the adoption of Ir-based materials and other noble metal materials also has the defects of high cost, poor stability and the like. The simultaneous performance of an NH₃-SCR reaction and a CO oxidation reaction on the same catalyst can effectively avoid the above-mentioned problems, and therefore also becomes an effective way to synergistically remove NOₓ and CO.

Regarding to the simultaneous occurrence of the NH₃-SCR reaction and the CO oxidation reaction, the catalyst must have a relatively high redox performance in order to achieve an efficient CO removal efficiency, while the high redox performance causes the occurrence of NH₃ oxidation at a high temperature so that the denitration efficiency decreases, and a temperature window for synergistic removal is narrowed. Thus, this is also a main problem existing in the current catalyst design. Moreover, the components in the actual industrial flue gases are complex, and the sulfur resistance of the catalyst is also a key factor required to be considered in catalyst design. Therefore, the development of a catalyst with a wide temperature window, high activity and high stability for synergistic removal of NOₓ and CO has wide application prospects and developing meaning.

The Chinese patent with a publication number of CN114192158A discloses a preparation method of a catalyst for synergistic removal of CO and NOₓ, in which copper, manganese and cerium ions are loaded onto the surface of a vanadium-tungsten-titanium catalyst, thereby achieving the oxidation of CO while removing NOₓ. However, this catalyst has the problems of narrow denitration temperature window (only about 80% of NO removal efficiency at 250° C.), poor sulfur resistance and the like.

The U. S. Patent with a publication number of U.S. Pat. No. 20,182,50661A1 discloses a catalyst for simultaneous removal of NOₓ and CO in flue gases. A noble metal Pd is introduced into a commercial catalyst, achieving the synergistic removal of NOₓ and CO. However, the introduction of the noble metal into this catalyst has the defects of high cost, poor resistance and the like.

The Chinese patents with publication numbers of CN113649020A, CN113694933A and CN114308053A disclose a titanium oxide denitration catalyst loaded with a high-entropy oxide, which focuses on low-temperature denitration at 250° C. or less, with a narrow denitration window, and therefore this catalyst is not suitable for medium-high temperature denitration at 300° C. or more.

### SUMMARY OF DISCLOSURE

The present disclosure provides a catalyst for synergistic removal of nitrogen oxides (NOₓ) and CO, which has the excellent characteristics of a wide temperature window, high activity, high stability and the like, achieving the synergistic control of NOₓ and CO in low cost and overcoming the excessive oxidation of NH₃ at a high temperature due to enhanced redox performance of the current catalyst, and the resistance problem of the catalyst.

Provided is a catalyst for synergistic removal of NOₓ and CO, having a core-shell structure with an aluminum oxide and/or titanium oxide loaded with a high-entropy oxide as a core and CePO₄ as a shell.

The present disclosure adopts a core-shell structure to solve the above technical problems, thereby encapsulating a high-entropy oxide having a relatively high redox performance inside CePO₄. CePO₄ is a good medium-low temperature denitration catalyst, and can achieve the efficient removal of NOₓ. Furthermore, due to its strong acidity, CePO₄ can effectively adsorb NH₃ in flue gases to prevent NH₃ from contacting the high-entropy oxide core, thereby reducing NH₃ excessive oxidation at high temperatures. Meanwhile, both CePO₄ and the high-entropy oxide possess good sulfur resistance, and therefore can maintain good synergistic removal efficiency in the actual industrial flue gases.

In the catalyst, the high-entropy oxide is preferably an oxide composed of a Cu element and at least four other metal elements selected from Co, Zn, Mn, Mg, Ni, and Fe, and all elements are present in an equimolar ratio.

Further preferably, a molar ratio of the Cu element to CePO₄ in the high-entropy oxide is 1:2-10.

Provided is also a preparation method of the catalyst of synergistic removal of NOₓ and CO, comprising the steps:
(1) performing vibratory ball milling, washing, drying and calcining by using aluminum isopropoxide and/or titanium isopropoxide and chlorides of five or more different metal elements as a precursor and adding P123 (poly (ethylene oxide)-poly (propylene oxide)-poly(ethylene oxide) triblock copolymer) and/or PEG (polyethylene glycol) as a template agent to obtain a high-entropy oxide inner core;
(2) adjusting the pH of a mixed solution containing H₃PO₄ and Ce(NO₃)₃ in a molar ratio of 1:1 to 9-11 using ammonia water, stirring sufficiently to form a gel, then sufficiently stirring the high-entropy oxide inner core obtained in step (1) with the gel, followed by vibratory ball milling, washing, drying and calcining, so as to obtain a high-entropy oxide loaded with CePO₄ seeds; and
(3) providing a mixed solution containing pyrophosphate and Ce(NO₃)₃ in equal stoichiometric ratios, adding ammonia water into the above mixed solution to obtain a clear solution, then adding the high-entropy oxide loaded with the CePO₄ seeds obtained in step (2) and urea and/or tetrapropylammonium hydroxide (TPAH) to form a slurry, and then after hydrothermal reaction, washing, drying and calcining a solid so as to obtain the catalyst for synergistic removal of NOₓ and CO.

In the preparation method of the present disclosure, first, the high-entropy oxide is prepared by a high-speed vibratory ball milling method, then a layer of CePO₄ is loaded onto the high-entropy oxide inner core, and finally a CePO₄ shell is grown through a hydrothermal reaction method. When NH₃ contacts with the catalyst, the CePO₄ of the shell, as a solid acid, can effectively adsorb NH₃ and prevent NH₃ from contacting the high-entropy oxide core. The NH₃-SCR reaction occurs on the outer layer of the catalyst and meanwhile the inner core high-entropy oxide of the catalyst has relatively high oxidation performance, so as to achieve a relatively high CO conversion rate. The prepared catalyst with the core-shell structure has good characteristics that CO is oxidized on the inner layer of the catalyst and NH₃ is adsorbed on the outer layer of the catalyst so as to avoid the occurrence of the NH₃ oxidation due to contact with the oxide on the inner layer. Meanwhile, the high-entropy oxide with an inner core structure has excellent SO₂ resistance due to its huge configuration entropy. The previous studies also show that the shell of CePO₄ has good SO₂ resistance. Therefore, the catalyst with such the structure can effectively avoid the NH₃ oxidation at the high temperature while achieving high CO oxidation performance. Meanwhile, the material of the catalyst has a certain sulfur resistance, and CePO₄ on the outer layer has a certain protection effect on the high-entropy oxide of the inner core. Therefore, the catalyst of the present disclosure is a good catalyst having a wide temperature window, high activity and high stability.

In step (1), a molar ratio of the aluminum isopropoxide and/or titanium isopropoxide to the chlorides is preferably 2:1-10.

In step (1), the chlorides are preferably all divalent metal chlorides and must comprise CuCl₂.

In step (1), a mass ratio of the template agent to the precursor is preferably 0.1-1:1.

In step (1), the temperature of the calcining is preferably 380-420° C., and the time of the calcining is preferably 3-5 h.

In step (2), the temperature of the calcining is preferably 380-420° C., and the time of the calcining is preferably 3-5 h.

In step (2), the mass percentage of the CePO₄ seeds in the high-entropy oxide loaded with the CePO₄ seeds is preferably 5%- 20%.

In step (3), a molar ratio of the urea and/or TPAH to Ce(NO₃)₃ is 1-10:1.

In step (3), the temperature of the hydrothermal reaction is preferably 120-200° C., and the time of the hydrothermal reaction is preferably 8-24 h.

In step (3), the temperature of the calcining is preferably 380-420° C., and the time of the calcining is preferably 3-5 h.

As a total inventive concept, the present disclosure also provides use of the catalyst in selective catalytic reduction and synergistic removal of nitrogen oxides (NOₓ) and carbon monoxide (CO).

Compared with the prior art, the present disclosure has the beneficial effects:
1) The catalyst with the core-shell structure prepared in the present disclosure can achieve the synergistic removal of NOₓ and CO with the wide temperature window, and can effectively avoid the oxidation of NH₃ due to enhanced redox performance of the catalyst.
2) Both the inner core and the shell structure of the catalyst prepared in the present disclosure have a certain sulfur resistance, thereby improving the stability of the catalyst and meeting complex working conditions under actual conditions.
3) The present disclosure adopts a transition metal precursor to achieve simultaneous synergistic removal of NOₓ and CO on the same catalyst, thereby reducing the cost for synergistic removal of pollutants.

### DETAILED DESCRIPTION OF PREFERRED EMBODIMENTS

Next, the present discloses will be further set forth in conjunction with specific embodiments. It should be understood that these embodiments are merely for explaining the present disclosure rather than limiting the scope of the present disclosure.

### EXAMPLE 1

### Preparation of a Catalyst

(1) Copper chloride, nickel chloride, ferrous chloride, cobalt chloride and magnesium chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:10.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and a gas firing hourly space velocity (GHSV)=40,000 h⁻¹. When the reaction temperature was 280° C., the NO conversion rate was 99.6%, the N₂ selectivity was 99.8%, and the CO conversion rate was 64.3%; and when the reaction temperature was 380° C., the NO conversion rate was 99.3%, the CO conversion rate was 100%, and the N₂ selectivity was 100%.

### EXAMPLE 2

### Preparation of a Catalyst

(1) Copper chloride, nickel chloride, ferrous chloride, cobalt chloride and magnesium chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.8%, the N₂ selectivity was 100%, and the CO conversion rate was 91.3%; and when the reaction temperature was 380° C., the NO conversion rate was 98.7%, the CO conversion rate was 100%, and the N₂ selectivity was 99.7%.

### EXAMPLE 3

### Preparation of a Catalyst

(1) Copper chloride, nickel chloride, manganese chloride, cobalt chloride and zinc chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.7%, the N₂ selectivity was 99.9%, and the CO conversion rate was 92.8%; and when the reaction temperature was 380° C., the NO conversion rate was 97.2%, the CO conversion rate was 100%, and the N₂ selectivity was 98.4%.

### EXAMPLE 4

### Preparation of a Catalyst

(1) Copper chloride, nickel chloride, ferrous chloride, cobalt chloride and zinc chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.6%, the N₂ selectivity was 99.9%, and the CO conversion rate was 92.1%; and when the reaction temperature was 380° C., the NO conversion rate was 98.2%, the CO conversion rate was 100%, and the N₂ selectivity was 98.8%.

### EXAMPLE 5

### Preparation of a Catalyst

(1) Copper chloride, nickel chloride, manganese chloride, cobalt chloride and ferrous chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.8%, the N₂ selectivity was 100%, and the CO conversion rate was 92.6%; and when the reaction temperature was 380° C., the NO conversion rate was 98%, the CO conversion rate was 100%, and the N₂ selectivity was 98.5%.

### EXAMPLE 6

### Preparation of a Catalyst

(1) Copper chloride, nickel chloride, manganese chloride, cobalt chloride, ferrous chloride and magnesium chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.7%, the N₂ selectivity was 100%, and the CO conversion rate was 94.2%; and when the reaction temperature was 380° C., the NO conversion rate was 95.5%, the CO conversion rate was 100%, and the N₂ selectivity was 97.2%.

### EXAMPLE 7

### Preparation of a Catalyst

(1) Copper chloride, nickel chloride, magnesium chloride, cobalt chloride, zinc chloride and ferrous chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide-5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was 40-60 meshes. The volume concentrations of initial gases were as follows: NO=NH₃=600 ppm, CO=1200 ppm, O₂=5 vol %, H₂O=5 vol %, N₂ is a balance gas, and GHSV=40,000 h⁻¹. When the reaction temperature was 280° C., the NO conversion rate was 99.5%, the N₂ selectivity was 99.8%, and the CO conversion rate was 94.3%; and when the reaction temperature was 380° C., the NO conversion rate was 95.4%, the CO conversion rate was 100%, and the N₂ selectivity was 96.7%.

### EXAMPLE 8

### Preparation of a Catalyst

(1) Copper chloride, nickel chloride, manganese chloride, cobalt chloride, zinc chloride, ferrous chloride and magnesium chloride in an equimolar ratio were mixed with aluminum isopropoxide and PEG-4000, and the above obtained mixture was subjected to high-speed vibratory ball milling for 120 min under the condition of 30 Hz, the product after vibratory ball milling was washed with ethanol and underwent vacuum drying at 40° C., and then the product after vacuum drying was calcined for 4 h at 400° C. to obtain a high-entropy oxide inner core. The addition amount of each component was as follows: a total molar amount of metal chlorides: a molar amount of aluminum isopropoxide=5:3.33; and 0.4 g of PEG-4000 was added into 5 mmol of metal chlorides.
(2) The pH of a mixed solution of phosphoric acid and cerium nitrate hexahydrate in a molar ratio of 1:1 was adjusted to 10 using strong ammonia water, the above mixed solution was sufficiently stirred to form a gel, then the inner core prepared in step (1) was added into the gel to be sufficiently stirred, wherein, the mass percentage of CePO₄ was 5%, the sample after stirring was then subjected to high-speed vibratory ball milling again, the sample after ball milling underwent vacuum drying at 40° C. after standing for a period of time, and subsequently the sample after vacuum drying was calcined at 400° C. for 4 h to form a high-entropy oxide loaded with CePO₄ seeds.
(3) An equal stoichiometric amount of cerium nitrate solution was dropwise added into a pyrophosphoric acid solution, then the pH of the above solution was adjusted to 4 using ammonia water, the high-entropy oxide loaded with the CePO₄ seeds prepared in step (2) and urea were added, wherein 2 mol of urea was added in per mole of cerium nitrate, then the mixture was subjected to hydrothermal reaction for 12 h at 180° C. after being sufficiently stirred for 30 min, the obtained sample was subjected to washing and vacuum drying, and then the sample after vacuum drying was calcined for 4 h at 400° C. to obtain a high-entropy oxide@CePO₄ catalyst. A molar ratio of a Cu element to CePO₄ in the high-entropy oxide was 1:5.

### Catalyst Activity Test

An activity experiment was carried out on a fixed bed reactor, the loading volume of the catalyst was 2.3 mL, and the granularity of the catalyst was40-60 meshes. The volume concentrations of initial gases were as follows: NO=NH₃=600 ppm, CO=1200 ppm, O₂=5 vol %, H₂O=5 vol %, SO₂=1200 ppm (when in use), N₂ is a balance gas, and GHSV=40,000 h⁻¹. When the reaction temperature was 280° C., the NO conversion rate was 99.9%, the N₂ selectivity was 100%, and the CO conversion rate was 95.6%; and when the reaction temperature was 380° C., the NO conversion rate was 94.3%, the CO conversion rate was 100%, and the N₂ selectivity was 96.4%. After 100 ppm SO₂ was introduced into the reaction gases, at 280° C., the NO conversion rate was 96.2%, the N₂ selectivity was 98.6%, and the CO conversion rate was 79.3%; and at 380° C., the NO conversion rate was 100%, the CO conversion rate was 100%, and the N₂ selectivity was 100%.

### Comparative Example 1

### Preparation of a Catalyst

A high-entropy oxide inner core was prepared based on the method in example 8 and CePO₄ was prepared by using a hydrothermal method. Then, the high-entropy oxide inner core and CePO₄ were subjected to dry blending so as not to form a core-shell structure of the present disclosure. A molar ratio of a Cu element to CePO₄ in the high-entropy oxide was 1:5.

### Catalyst Activity Test

The conditions for the catalyst activity test were the same as those in example 8. When the reaction temperature was 280° C., the NO conversion rate was 99.8%, the N₂ selectivity was 100%, and the CO conversion rate was 96%; and when the reaction temperature was 380° C., the NO conversion rate was 76.4%, the CO conversion rate was 100%, and the N₂ selectivity was 80.2%. After 100 ppm SO₂ was introduced into the reaction gases, at 280° C., the NO conversion rate was 96.1%, the N₂ selectivity was 99.8%, and the CO conversion rate was 61.4%; and at 380° C., the NO conversion rate was 100%, the CO conversion rate was 91.5%, and the N₂ selectivity was 100%.

By comparing comparative example 1 with example 8, it is found that the core-shell structure of the present disclosure has the following two advantages that 1, high NO conversion rate at the high temperature, and meanwhile the CO conversion rate at the low temperature can also be maintained; and 2, good sulfur resisting effect on CO oxidation and high oxidation rate.

In addition, it should be understood that after reading the contents of the present disclosure as described above, those skilled in the art can make various changes or modifications, and these equivalent forms similarly fall within the scope as defined in claims appended in the present disclosure.

We claim:

1. A catalyst for synergistic removal of nitrogen oxides (NOₓ) and carbon monoxide (CO), having a core-shell structure with aluminum oxide and/or titanium oxide loaded with a high-entropy oxide as a core and CePO₄ as a shell, wherein the core is also loaded with a layer of CePO₄;
the high-entropy oxide being an oxide composed of a Cu element and at least four metal elements selected from Co, Zn, Mn, Mg, Ni and Fe.

2. The catalyst according to claim 1, wherein all metal elements in the high-entropy oxide are in an equimolar ratio.

3. The catalyst according to claim 2, wherein a molar ratio of the Cu element to CePO₄ in the high-entropy oxide is 1:2-10.

4. A preparation method of the catalyst according to claim 1, comprising the steps:
(1) performing vibratory ball milling, washing, drying and calcining by using aluminum isopropoxide and/or titanium isopropoxide and chlorides of five or more different metal elements as a precursor and adding P123 and/or polyethylene glycol (PEG) as a template agent to obtain a high-entropy oxide inner core;
(2) adjusting the pH of a mixed solution containing H₃PO₄ and Ce(NO₃)₃ in a molar ratio of 1:1 to 9-11 using ammonia water, stirring sufficiently to form a gel, and then sufficiently stirring the high-entropy oxide inner core obtained in step (1) with the gel, followed by vibratory ball milling, washing, drying and calcining, so as to obtain a high-entropy oxide loaded with CePO seeds; and
(3) providing a mixed solution containing pyrophosphate and Ce(NO₃)₃ in equal stoichiometric ratios, adding ammonia water into the above mixed solution to obtain a clear solution, then adding the high-entropy oxide loaded with the CePO₄ seeds obtained in step (2) and urea and/or tetrapropylammonium hydroxide (TPAH) to form a slurry, and then after hydrothermal reaction, washing, drying and calcining a solid so as to obtain the catalyst for synergistic removal of NOₓ and CO.

5. The preparation method according to claim 4, wherein in step (1):
a molar ratio of the aluminum isopropoxide and/or titanium isopropoxide to the chlorides is 2:1-10;
the chlorides are all divalent metal chlorides and must comprise CuCl₂;
a mass ratio of the template agent to the precursor is 0.1-1:1; and
the temperature of the calcining is 380-420° C., and the time of the calcining is 3-5 h.

6. The preparation method according to claim 4, wherein in step (2):
the temperature of the calcining is 380-420° C., and the time of the calcining is 3-5 h; and
the mass percentage of the CePO₄ seeds in the high-entropy oxide loaded with CePO₄ seeds is 5%- 20%.

7. The preparation method according to claim 4, wherein in step (3):
a molar ratio of the urea and/or TPAH to Ce(NO₃)₃ is 1-10:1;
the temperature of the hydrothermal reaction is 120-200° C., and the time of the hydrothermal reaction is 8-24 h; and
the temperature of the calcining is 380-420° C., and the time of the calcining is 3-5 h.

8. Use of the catalyst according to claim 1 in selective catalytic reduction and synergistic removal of NOₓ and CO.
